(19) United States
(12) Patent Application Publication
(10) Pub. No.: US 2008/0311844 A1
(43) Pub. Date: Dec. 18, 2008

(54) Multiple Input Receiver In Satellite Communication System

(75) Inventor: Thomas Eidenschink, Carlsbad, CA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 12/050,767

(22) Filed: Mar. 18, 2008

Related U.S. Application Data
(60) Provisional application No. 60/895,512, filed on Mar. 19, 2007.

(51) Int. Cl. H04H 40/90

(52) U.S. Cl. 455/3.02

(57) ABSTRACT

Satellite communication systems and methods are disclosed that provide local and regional data to a subscriber terminal utilizing a single receiver. Regional data may be transmitted over a wide beam and the local data may be transmitted over one of a plurality of localized spot beams such as, for example, a four color spot pattern. Moreover, the data may be multiplexed using TDMA, FDMA, and/or OFDMA techniques. In one embodiment, the regional data is transmitted in a first time slot over a first frequency band and the local data is transmitted in a second timeslot. Each set of localized data may be transmitted over a sub-band of the first frequency band.

### CROSS-REFERENCES TO RELATED APPLICATIONS

This application is a non-provisional and claims the benefit of U.S. Provisional Patent Application No. 60/895,512, filed Mar. 19, 2007, entitled “Multiple Input Receiver In Satellite Communication System,” which is incorporated herein by reference in its entirety.

### BACKGROUND

Satellite communication may include satellites that transmit data in a broad beam that transmit data over a large geographic area or narrow beams that transmit data over a localized area. For example, as shown in FIG. 3A a broad beam 325 covers the continental United States while a number of narrow beams 305 are localized over a specific geography. In order to receive data from both a broad beam and a narrow beam subscriber terminals must have more than one receiver. There is a need in the art for providing regional data and local data to a user using a single receiver.

### SUMMARY

A method for receiving both regional data and local data from one or more satellites and/or terrestrial repeaters at a satellite subscriber terminal is provided according to one embodiment. The method may comprise receiving the regional data during a first time slot and receiving the local data during a second time slot, where the local data is multiplexed in one of a plurality of frequency bands. The method may further include demultiplexing the local data. The local data may be transmitted in a spot beam and the regional data may be transmitted in a broad beam. Each of the plurality of frequency bands may include broadcast and local data for a specific locality and the data may be transmitted within a spot beam covering the specific locality. The regional data may be received within a first frequency band and the plurality of frequency bands may include frequency sub-bands within the first frequency band. The local data may be multiplexed using frequency division multiple access techniques. The local data may also be multiplexed in a frequency reuse pattern similar to cellular networks.

A satellite subscriber terminal configured to receive both regional data and local data from one or more satellites or terrestrial repeaters is provided according to another embodiment. The subscriber terminal may include at least a receiver and a demultiplexer. The receiver may be configured to receive regional data within a first time slot and local data within a second time slot and the local data may be multiplexed within one of a plurality of frequency bands. The demultiplexer may be configured to demultiplex the local data from the plurality of frequency bands. The demultiplexer may comprise a processor configured to perform a demultiplexing function. The regional data may be transmitted within a first frequency band and the plurality of frequency bands may be frequency sub-bands within the first frequency band. The local data may be multiplexed using frequency division multiple access techniques.

A satellite subscriber terminal configured to receive both regional data and local data from one or more satellites and/or terrestrial repeaters is provided according to another embodiment. The subscriber terminal may include means for receiving regional data from a first satellite within a first time slot and local data from a second satellite within a second time slot and means for demultiplexing the local data from the plurality of frequency bands. The local data may be multiplexed within one of a plurality of frequency bands. The first and second satellite may be the same satellite. The local data may be multiplexed within the second timeslot, for example, using frequency division multiple access techniques.

A method for transmitting both regional data and local data to a plurality of subscriber terminals is also provided according to another embodiment. The method may include any of the following steps in any order or combination: 1) receiving regional data from a first gateway; 2) receiving a plurality of local data from a second gateway; 3) multiplexing the plurality of local data, wherein each of the plurality of local data is multiplexed into a sub-frequency band within a first frequency band; 4) transmitting at least a portion of the regional data in a first time slot over the first frequency band; and 5) transmitting at least a portion of the multiplexed local data in a second time slot over the first frequency band. Each of the plurality of local data may be transmitted in a localized spot beam and the regional data may be transmitted in a broad beam. The first gateway and the second gateway may be the same gateway. The plurality of local data may be multiplexed using frequency division multiple access techniques.

A satellite configured to transmit data to a plurality of subscriber terminals over a single wide beam and a plurality of narrow beams is also provided according to another embodiment. The satellite may include a first antenna configured to transmit regional data to each of the plurality of subscriber terminals over a single wide beam and a second antenna configured to transmit a plurality of sets of local data to the plurality of subscriber terminals over a plurality of narrow beams. Each narrow beam may transmit the sets of local data to a subset of the plurality of subscriber terminals. The first antenna and the second antenna may be the same antenna. The regional data may be transmitted over the first antenna in a first time slot and the plurality of sets of local data may be transmitted over the second antenna in a second time slot. The satellite may be configured to transmit each set of local data over separate narrow beams. The plurality of narrow beams may comprise multi-color frequency reuse beam patterns. The regional data may be transmitted within a first frequency band and each set of local data is transmitted within a sub frequency band that is a subset of the first frequency band.

A single satellite subscriber terminal that receives data from both a broad beam and a narrow beam is disclosed. The data contained in the broad beam and the narrow beam may be multiplexed using, for example, time division multiple access (TDM), frequency-division multiplexing (FDM), a combination of the two, or a similar multiplexing scheme. The satellite or satellites may multiplex more than one narrow beam with at least one broad beam. The data contained in the broad beam and the narrow beam may be transmitted from the same source or from different sources. The satellite subscriber terminal receives both the broad beam and the narrow beam through the same receiver.

A satellite communication system that transmits data in a broad beam and plurality of narrow beams that are multiplexed using hybrid time-division and frequency-division multiplexing. A plurality of narrow beams may be multiplexed using FDM. The frequency-division multiplexed plurality of narrow beams may be time-division multiplexed with a broad beam.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIGS. 1A-D depict diagrams of embodiments of a satellite system.

FIGS. 2A-D show block diagrams of transmitters and receivers according to various embodiments of the disclosure.

FIG. 3A shows an exemplary spot beam map according to one embodiment.

FIG. 3B shows a beamforming map with two satellites according to one embodiment.

FIG. 3C shows another example of a two satellite beamforming map according to one embodiment.

FIG. 4A shows a typical TDMA data signal.

FIG. 4B shows a typical FDMA data signal.

FIG. 5A shows a narrow beam spot pattern.

FIG. 5B shows a narrow beam spot pattern within a single broad beam.

FIG. 6A shows an FDMA approach to transmitting both broad and narrow beams from a satellite to receivers according to one embodiment.

FIG. 6B shows an TDMA approach to transmitting both broad and narrow beams from a satellite to receivers according to one embodiment.

FIG. 6C shows a combination FDMA and TDMA approach to transmitting both broad and narrow beams from a satellite to receivers according to one embodiment.

FIG. 7 shows a flowchart of a method for receiving broadcast and local data according to one embodiment.

FIG. 8 shows a flowchart of a method for transmitting broadcast and local data according to another embodiment.

FIG. 9 shows yet another flowchart of a method for transmitting broadcast and local data according to another embodiment.

### DESCRIPTION

The ensuing description provides preferred exemplary embodiment(s) only and is not intended to limit the scope, applicability or configuration of the disclosure. Rather, the ensuing description of the preferred exemplary embodiment(s) will provide those skilled in the art with an enabling description for implementing a preferred exemplary embodiment. It should be understood that various changes may be made in the function and arrangement of elements without departing from the spirit and scope as set forth in the appended claims.

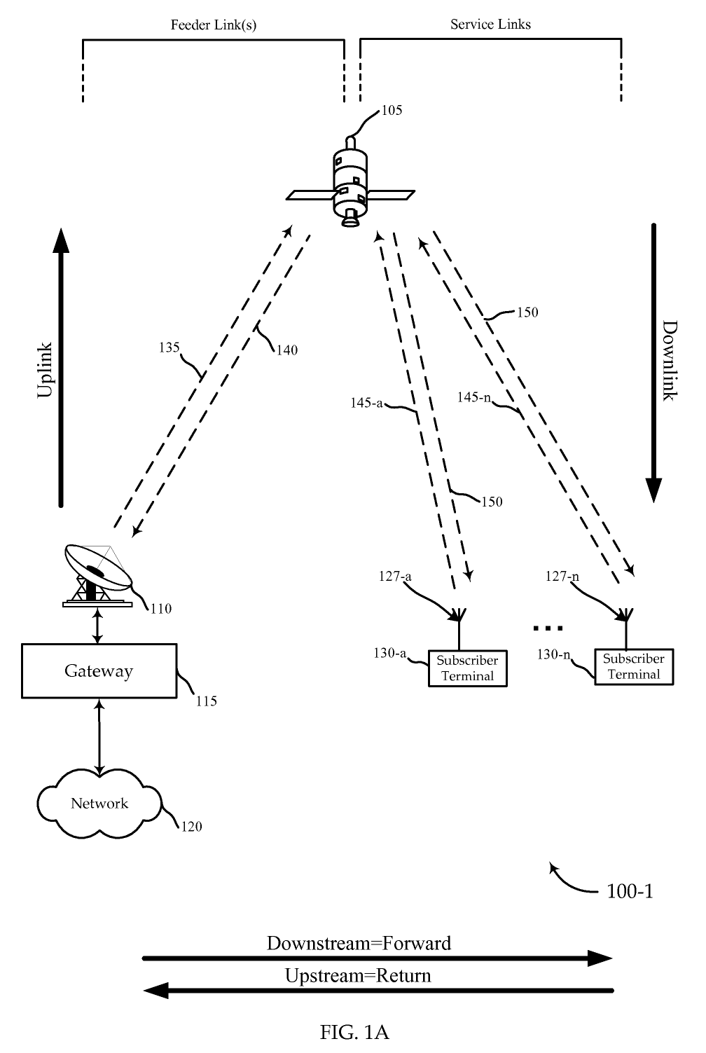

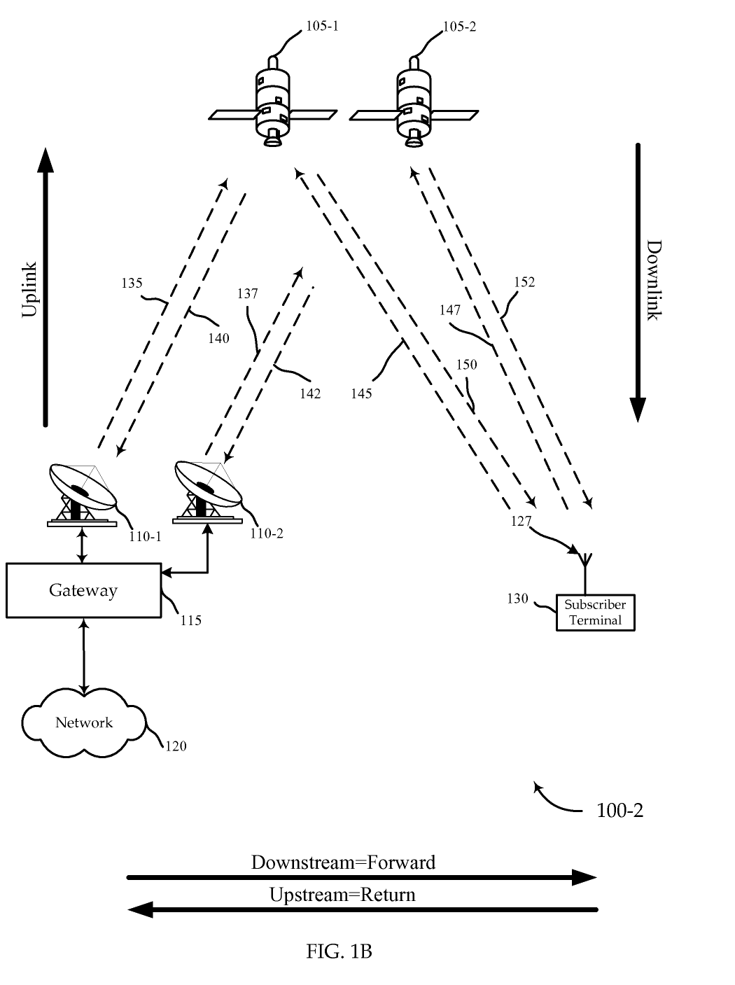

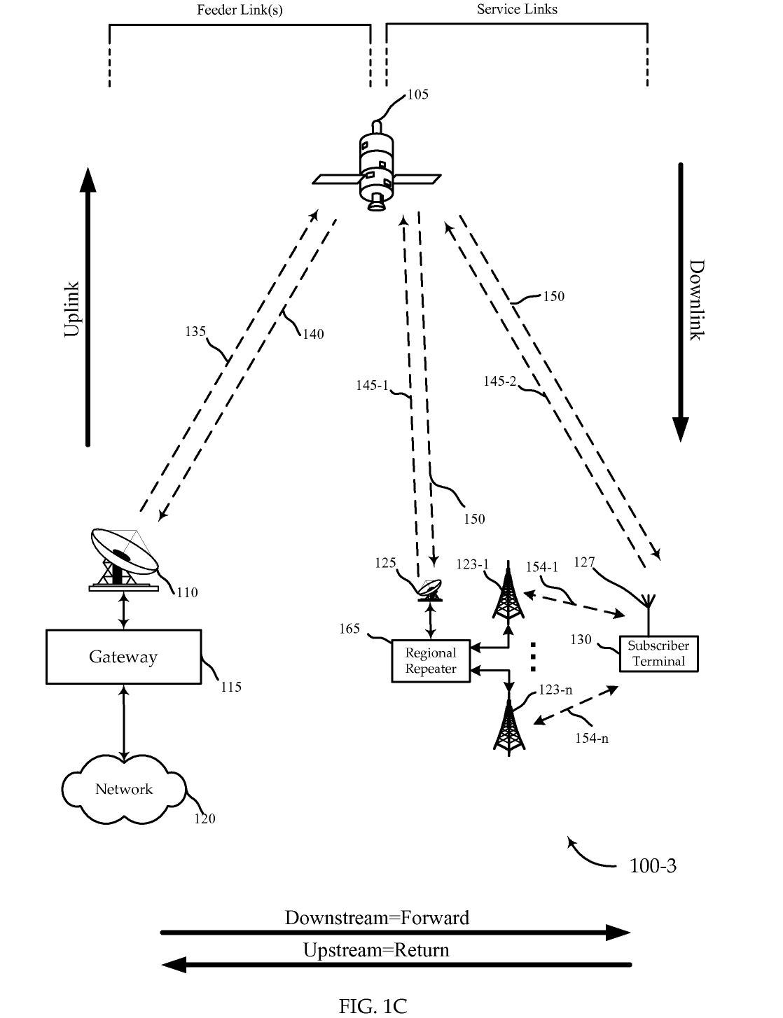

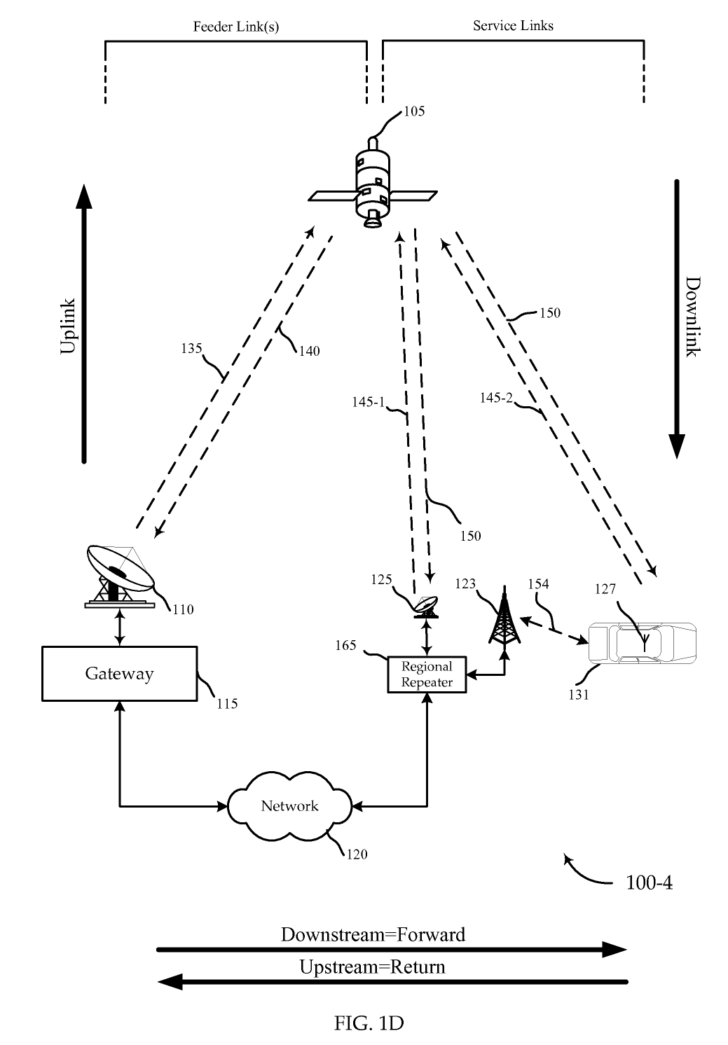

Referring initially to FIG. 1A, an embodiment of a satellite system 100-1 is shown. In this embodiment, a gateway 115 is coupled with a network 120, for example, the Internet. The gateway 115 uses a satellite antenna 110 to bi-directionally communicate with a satellite 105 on a feeder link. A feeder link 135 communicates information from the gateway 115 to the satellite 105, and another feeder link 140 communicates information from the satellite 105 to the gateway 115. Although not shown, there may be a number of gateways 115 in the system 100.

The satellite 105 could perform switching or be a bent-pipe. Information bi-directionally passes through the satellite 105. The satellite 105 could use antennas or phased arrays when communicating. The communication data may be focused into narrow beams that are focused on a localized geographic area; for example, a large metropolitan area. Similarly, the communication data may be focused into broad beams that cover large geographic areas, for example, the continental US (CONUS). The data may also be communicated using both narrow beams and broad beams.

As will be discussed in more detail, the service signal 150 from the satellite 105 may be comprised of a regional component that is sent to all subscriber terminals within a broad beam and a plurality of local or narrow beam data that may be transmitted only to subscriber terminals 130 within a specific localized geography covered by the narrow beam. For example, narrow beams may be directed toward a specific geographic locality. The data within the broad and narrow beams may be sent using a modulation scheme such as, for example, TDM, FDM, a combination of the two or a similar multiplexing scheme. The data within the broad and narrow beams may use the same carrier frequency and/or frequency band. A single receiver at the subscriber terminal may receive data from both broad beams and narrow beams using a single antenna.

The subscriber terminals 130 in this embodiment may be bi-directionally coupled to the satellite 105 to provide connectivity with the network 120. Each subscriber terminal 130 can receive information through the downlink signal 150 from the satellite 105, and transmitted information may be sent through a return service 145. Each subscriber terminal 130 may to send information to the satellite 105 and ultimately the gateway 115 through a return service 145.

Satellite subscriber terminals may have multiple antennas coupled with a single receiver. The subscriber terminal 130 can be in a fixed or nomadic location, or can be mobile. In this embodiment, the subscriber terminal 130 interacts with a single transceiver in the satellite 105. Other embodiments could allow the subscriber terminal 130 to interact with multiple transceivers that may communicate with orbital or non-orbital assets (e.g., air, ground or sea based). Some embodiments of the subscriber terminal 130 allow switching between these modes.

The network 120 may be any type of network and can include, for example, the Internet, an IP network, an intranet, a wide-area network (“WAN”), a local-area network (“LAN”), a virtual private network, the Public Switched Telephone Network (“PSTN”), a cluster of computers, and/or any other type of network supporting data communication between devices described herein, in different embodiments. A network 120 may include both wired and wireless connections, including optical links. Many other examples are possible and apparent to those skilled in the art in light of this disclosure. As illustrated in a number of embodiments, the network may connect the gateway 115 with other gateways (not pictured), which are also in communication with the satellite 105.

Referring next to FIG. 1B, another embodiment of a satellite system 100-2 is shown. This embodiment has two satellites 105 that act cooperatively as multiple transmitters and receivers. The satellites 105 are geographically separated by orbit or orbital slot. Low earth orbit (LEO), geostationary or elliptical orbits may be variously used by the satellites 105. The satellites may each send a unique signal. For example, the first satellite 105-1 may transmit a broad beam with data to a number of subscriber terminals 130 over a large geographic area, for example, CONUS. The second satellite 105-2 may send a narrow beam of data to a smaller number of subscriber terminals 130 in a smaller geographic area. The signals from the satellites may be sent using the same carrier frequency or band and may be timed according to TDM, FDM, a combination of the two, or the like. The second satellite 105-2 may switch between narrow beams focused on localized geographic locations and broad beams focused on a large geographic area.

With reference to FIG. 1C, yet another embodiment of the satellite system 100-3 is shown. This embodiment includes a number of regional repeaters 165. The regional repeaters 165 are distributed around to allow enhanced coverage. At any given moment, a subscriber may be able to communicate with a few local repeaters 165 and/or the satellite 105. A service link between the local repeater antenna 125 and the satellite 105 allows relaying activity on a terrestrial link(s) 154. The signal sent from the satellite 105 and the signal from the local repeater 165 may be sent using the same carrier frequency or within the same frequency spectrum. Furthermore, the satellite 105 may send a broad beam and the local repeater 165 may transmit data over a local area.

Referring to FIG. 1D, still another embodiment of the satellite system 100-4 is shown. This embodiment shows a local repeater 165 that can be used as a return service link 145, a service link 150 or a network connection to relay communication over the terrestrial link 154. Each local repeater 165 in this embodiment uses a single transceiver and antenna 123 for terrestrial communication. An algorithm can divide traffic between the service link and network link when both are available. This embodiment also shows the subscriber terminal 131 as an automobile. The subscriber terminal 131 may also be a boat, an airplane, a train, a bus or the like.

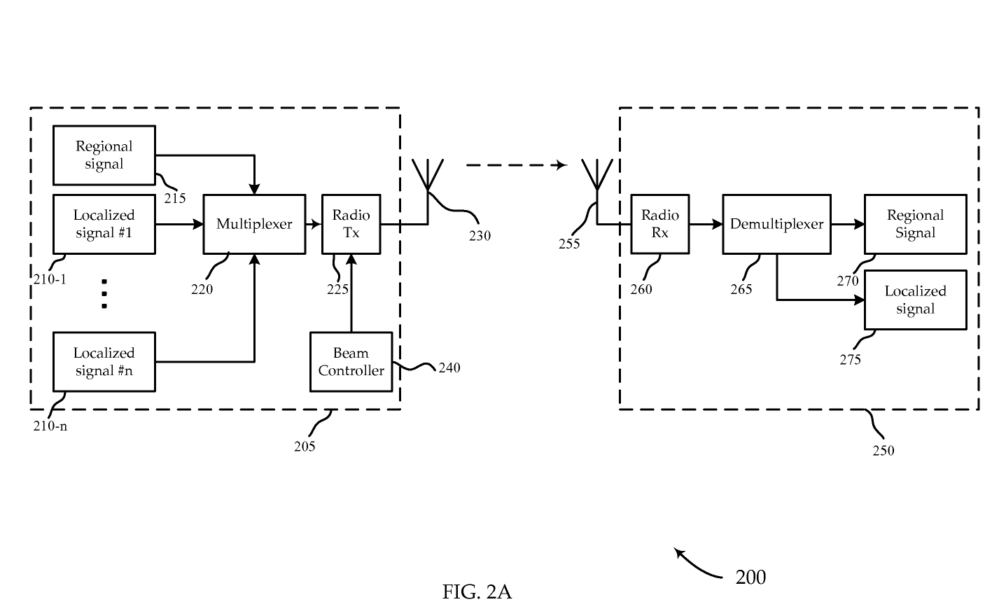

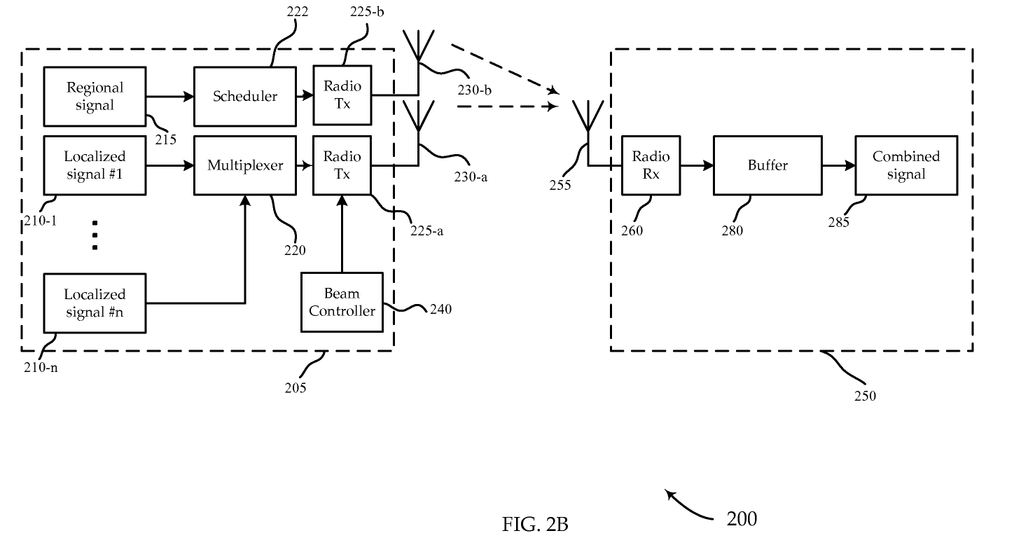

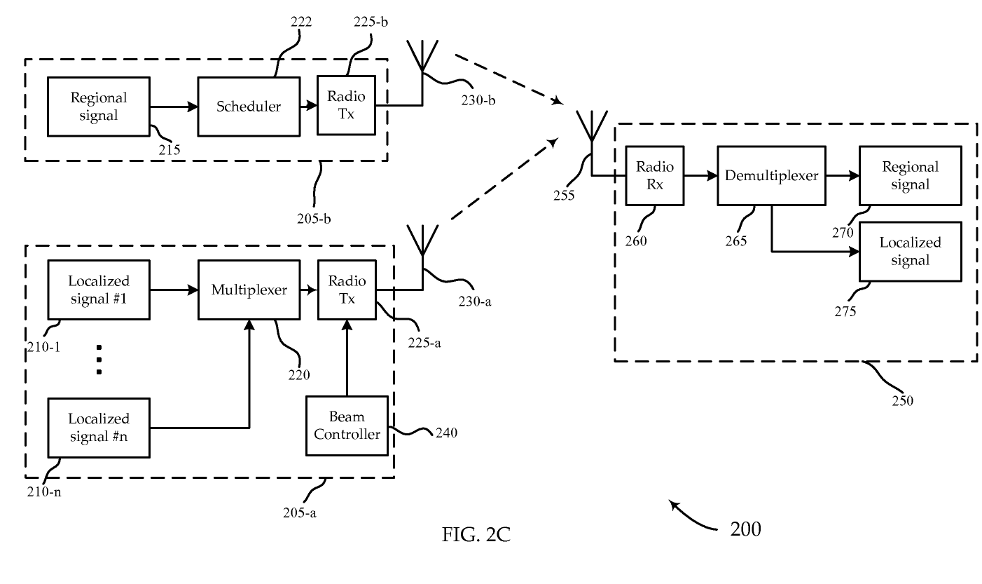

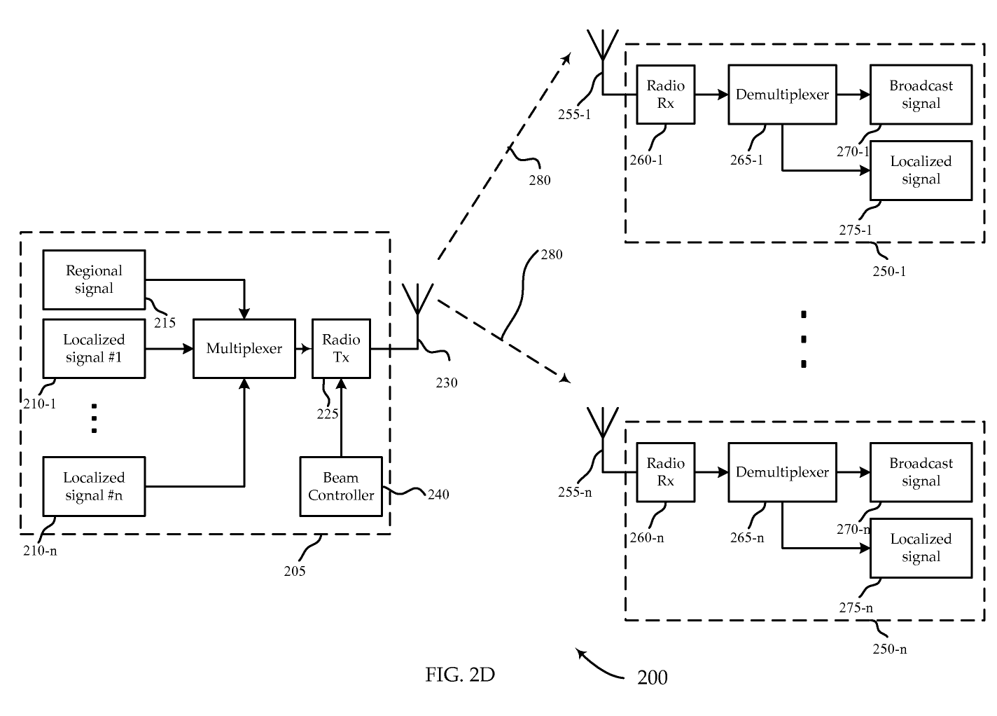

Turning now to FIG. 2A, a system 200 is shown which illustrates a communication scheme that may be leveraged in the system 100 set forth in FIG. 1. The system includes a transmitter 205, such as a satellite or a terrestrial transmitter, and a subscriber terminal 250. The transmitter 205 may transmit both regional 215 and a plurality of localized data 210 using a single radio 225 and a single antenna 230. The regional data 215 and the local data 210 may be multiplexed using a multiplexer 220. The multiplexer 220 may be a hardware or software multiplexer. In one embodiment, the multiplexer 220 multiplexes the broadcast and local data using FDM, TDM, a combination of the two, or a similar multiplexing scheme. The signal is sent to a radio transmitter 225 and then transmitted through an antenna 230. A beam controller 240 may be used to synchronize the size and direction of the broad and/or narrow beams. The antenna 230 may be a phased array antenna. Various beam forming techniques may be used to transmit the data in large beams and a plurality of narrow beams.

The signal may be received at a single antenna 255 and radio 260 of a satellite subscriber terminal 200. The signals may be demultiplexed into a broad beam data 270 and a narrow beam data 275 with a demultiplexer 265. The broad and narrow beam data may be buffered. In other embodiments, only one set of narrow beam data is received at the satellite subscriber terminal. The regional data may be transmitted over a first bandwidth in one timeslot, the local data may be transmitted over a sub-band within the first bandwidth in another timeslot. The transmitter may send control information to the receiver such as timeslot information, data segment lengths, sub-band information, number of segments, error control information, etc.

Each antenna 230, 255 may be made up of one or more individual antenna elements. Each antenna may be a fixed or phased array of, for example, monopoles or reflectors, or any other type or configuration known in the art. A variety of types of beamforming may be used by adaptively controlling the processing of patterns, orientations, and polarizations to improve performance, as discussed below or known in the art.

In one embodiment, various techniques are used (e.g., by the systems 100, 200 of FIGS. 1 or 2) to process data streams. In one embodiment, diversity techniques (e.g., selection combining, equal gain combining, MRC, certain space-time codes, or hybrid methods) are used. In another embodiment, spatial multiplexing techniques may be used to process independent data streams. In other embodiments, spatial multiplexing techniques may be used in combination with diversity techniques and/or space-time codes. A variety of techniques may be used, including various space-time block codes, space-time trellis codes, super-orthogonal space time trellis codes, differential space-time modulation, decision feedback equalization combined with zero forcing or MMSE (e.g., BLAST architectures), and combination techniques.

As used throughout this application data that is transmitted over a narrow beam is referred to as narrow beam data. Local data may comprise, for example, multicast video, unicast IP data, localized data, local television data, internet data, interactive data, voice over IP, etc. Also, as used throughout this application data transmitted over a broad beam is referred to as a broad beam data. Regional data may include, for example, broadcast television information, multicast video, unicast IP data, etc.

FIG. 2B shows a communications scheme according to another embodiment. In this embodiment, the transmitter 205 includes two antennas 230-a, 230-b. The narrow beam data 210 may be multiplexed at the multiplexer 220, prepared for transmission at a radio 225-a, and transmitted from an antenna 230-a. The antenna used to transmit the narrow beam data 230-a may be steered to form various narrow beams directed at specific geographic locations, for example, forming a four color pattern. As another example, the transmitter antenna 230-a may beamform electronically using an array of antennas. The transmitter antenna 230-a may include a plurality of antennas, each producing a narrow beam in a unique direction. The narrow beam data 210 may be transmitted during a dedicated timeslot following a TDM process.

The broad beam data 215 may also be transmitted during a dedicated timeslot as directed by the scheduler 222, prepared by the radio 225-b and transmitted over a large geographical region through antenna 230-b. The broad beam data may be transmitted using portions of the same frequency as the narrow beam data 210. Timeslots may be used to transmit narrow beam data and broad beam data to ensure the data does not overlap.

The subscriber terminal 250, according to this embodiment, receives the combined signal at an antenna 255 and processes the signal through a radio 260. The data may then be buffered at block 280. The narrow beam data and broad beam data may be combined 285. The narrow beam data may be buffered separately from the broad beam data.

FIG. 2C shows a two satellite communications scheme according to another embodiment. A broad beam data 215 is transmitted from a first transmitter 205-b using a scheduler 222, a radio 225-b and an antenna 230-b. Narrow beam data 210 may be transmitted from a second transmitter 205-a using a multiplexer 220, radio, 225-1 and antenna 230-a.

Localized signals 210 may include, for example, local broadcasting information for satellite radio or satellite television. The narrow beam data may be transmitted only to the localities associated with the local broadcasting information using a narrow beam from the transmitter. Broad beam data, for example, may include national radio or television programming. For example, a national television program may be broadcast nationwide to consumers with a satellite television receiver. Local commercials may be transmitted as narrow beam data only to specific localities, so that consumers in different geographic locations will view the same television program and view different local commercials. Local information, for example, Amber Alerts, weather information, or sports scores, may also be transmitted with the narrow beam data. Furthermore, narrow beam data may also include Internet data. Broad beam data and narrow beam data may be transmitted with a single carrier frequency using TDM. In another embodiment, the broad beam data and the narrow beam data may be transmitted within the same frequency band using FDM. In another embodiment, local programming, such as local news, sports, or specialty shows may be transmitted as narrow beam data.

FIG. 2D illustrates a communication scheme similar to that shown in FIG. 2A. The system includes a single transmitter 205, as shown in FIG. 2A, and more than one subscriber terminals 250. The figure shows two subscriber terminals 250-1, 250-n. Any number of subscriber terminals 250 may be used. The transmitter transmits broad beam data 215 and more than one narrow beam data signals 210 with a single carrier signal 280. The broad beam data 251 and narrow beam data 210 are multiplexed with a single carrier signal with a multiplexer 220. The regional signal is transmitted in a broad beam to more than one satellite subscriber terminal, while the local signals are each sent in a narrow beam to a specific geographic location. Each satellite subscriber terminal antenna 255 receives at least the regional signal and/or at least one local signal. At each satellite subscriber terminal 250, demultiplexers 265 include logic to parse the regional signal 270 and the local signals 275. The satellite subscriber terminal 250 may also include logic that determines which local signal was transmitted to the spot within which the satellite subscriber terminal is located. For example, if the regional and local signals are multiplexed using TDM, each narrow beam transmits to a specific geographic spot only during a specific time bin. The satellite subscriber terminal may include logic to determine the proper time bin to listen for narrow beam data. The transmitter may send control signals specifying which time bins correspond to which geographic spots.

The satellite subscriber terminal may also include an amplifier and/or an analog to digital converter. In one embodiment the demultiplexer is placed after the amplifier and before a converter.

The above descriptions related to FIGS. 2A-D are examples only. The satellite subscriber terminal described by embodiment provide for a single receiver that receives both broadcast and narrow beam data from one or more satellites or terrestrial repeaters. The signals may be transmitted through a single carrier signal using techniques such as, for example, TDM, TDMA, FDM, FDMA, OFDMA, CSDM, CSMA, TD-SCDMA, or the like. In other embodiments, narrow beam data may be transmitted from a terrestrial antenna or from a plurality of satellites. The broad beam data may also be transmitted from a plurality of satellites.

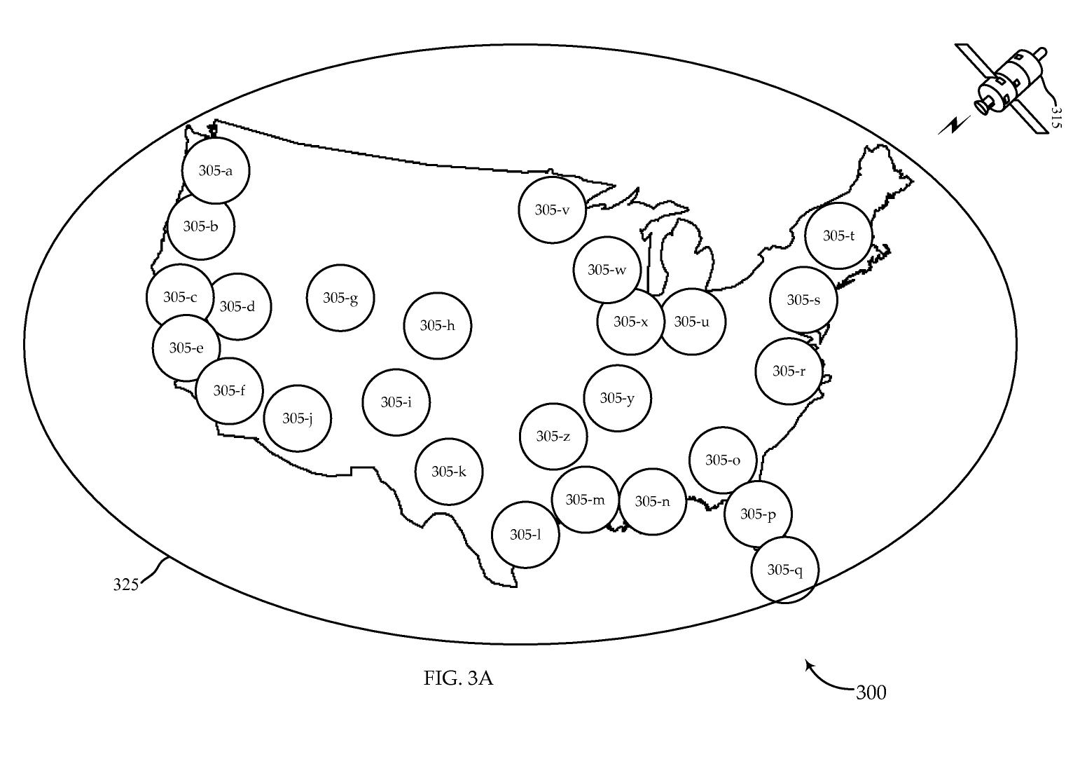

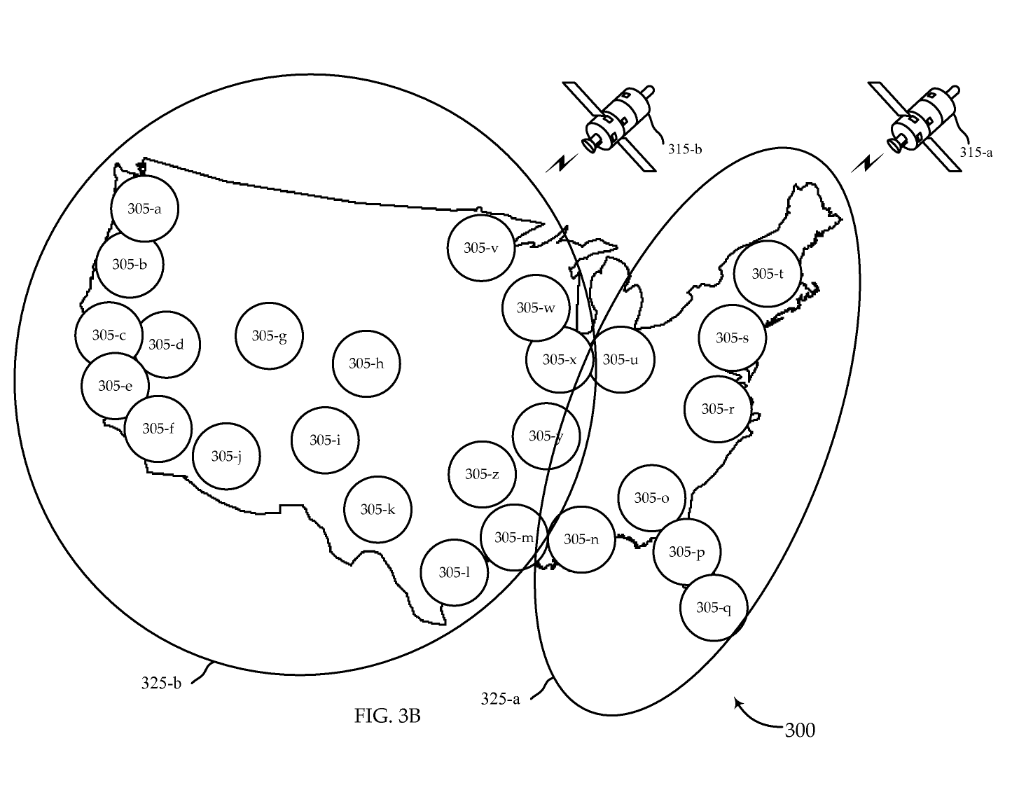

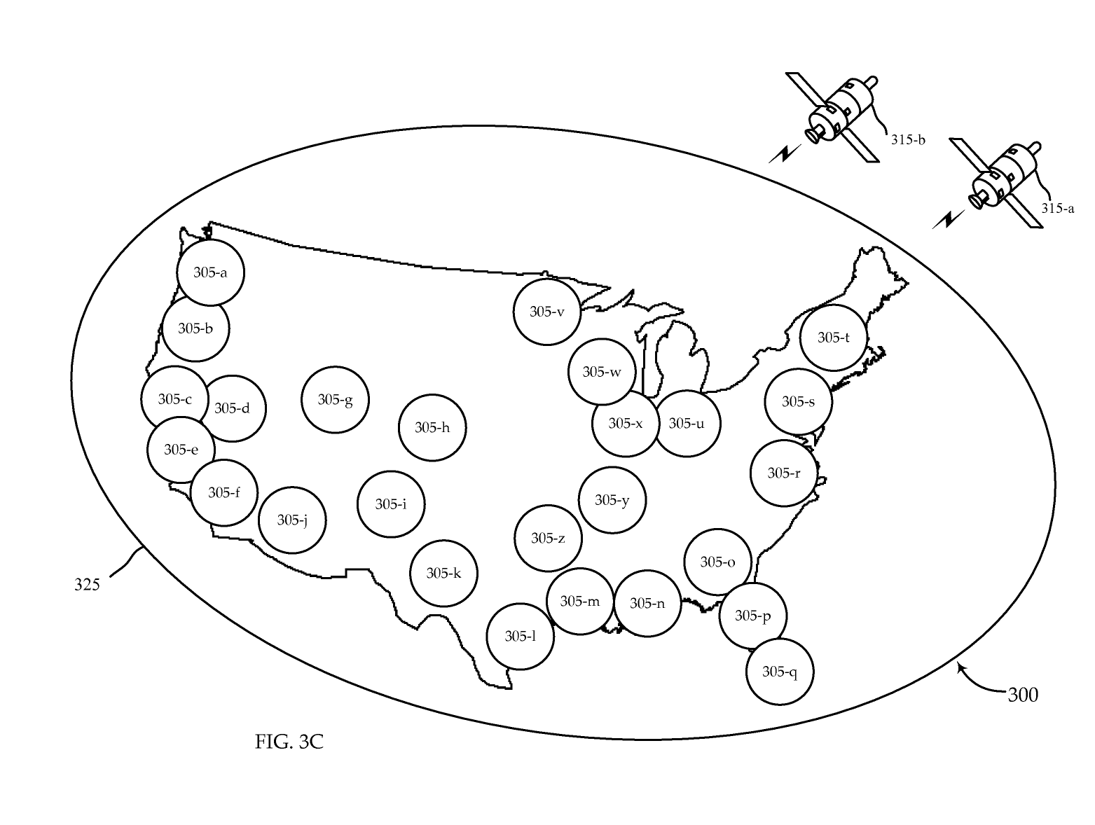

FIG. 3A shows an exemplary spot beam map according to one embodiment. According to embodiments of the invention, a satellite 315 may broadcasts a broad beam 325 over the United States and transmit a plurality of narrow beams 305 to various locations across the map. The broad beam may cover the Continental US (CONUS) or any other geographic region. While FIG. 3A shows 26 narrow beams, two or more narrow beams may be transmitted. The broadbeam 325 could be transmitted in certain timeslots, while all the narrow beams are then transmitted in other timeslots separate from the broadbeam 325. Frequency reuse would be deployed on the spot beams to prevent interference between narrow beams, but the same frequency space would be used for the broadbeam 325. FIG. 3B shows two broadbeams 325 covering the continental United States.

FIG. 3C shows another example of a two satellite map according to one embodiment. In this embodiment the first satellite 315-a transmits broad beam data 325 and the second satellite 315-b transmits narrow beam data 305. A time or frequency division scheme would be deployed to coordinate transmissions from each satellite.

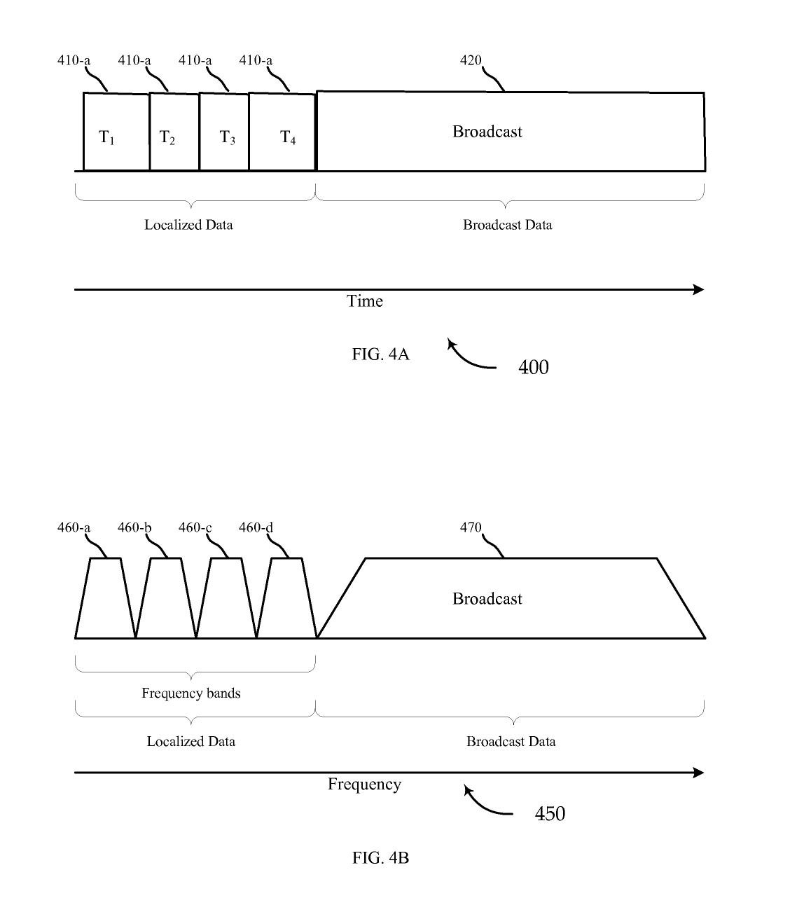

FIG. 4A shows a TDM data signal 400. The data signal 400 in this embodiment includes four local timeslots 410-a, 410-b, 410-c, 410-d and a regional timeslot 420. The width of the timeslots may be static or dynamically determined. Narrow beam data is transmitted to different geographic locations during the first four timeslots 410-a, 410-b, 410-c, 410-d. While four timeslots are shown, any number of timeslots may be used and the timeslots may be of any size. For example, each narrow beam data timeslot 410-a, 410-b, 410-c, 410-d may be 10 ms. A complete data packet or portions of a data packet may be sent from the satellite during each timeslot. During the regional timeslot 420, broad beam data is transmitted over the large geographic area. The regional timeslot 420, for example, may be 60 ms. Both service links may use TDM or TDMA.

FIG. 4B shows a FDM frequency allocation scheme 450. The allocated frequency bandwidth is further subdivided into a number of sub-channels 460. For example, four sub-channels 460-a, 460-b, 460-c, 460-d. Narrow beam data is transmitted to various geographic spots through the four orthogonal sub-channels. The broad beam data 470 may be transmitted through a large sub-channel. In other embodiments broad beam data may be transmitted in a different frequency band. Both service links may use TDM (or TDMA), FDM (or FDMA), a combination of the two or a similar multiplexing scheme.

Embodiments may be used in a terrestrial radio access network (T-RAN), a satellite radio access network (S-RAN) or a combination of the two. Furthermore, embodiments may communicate television programming and/or network data.

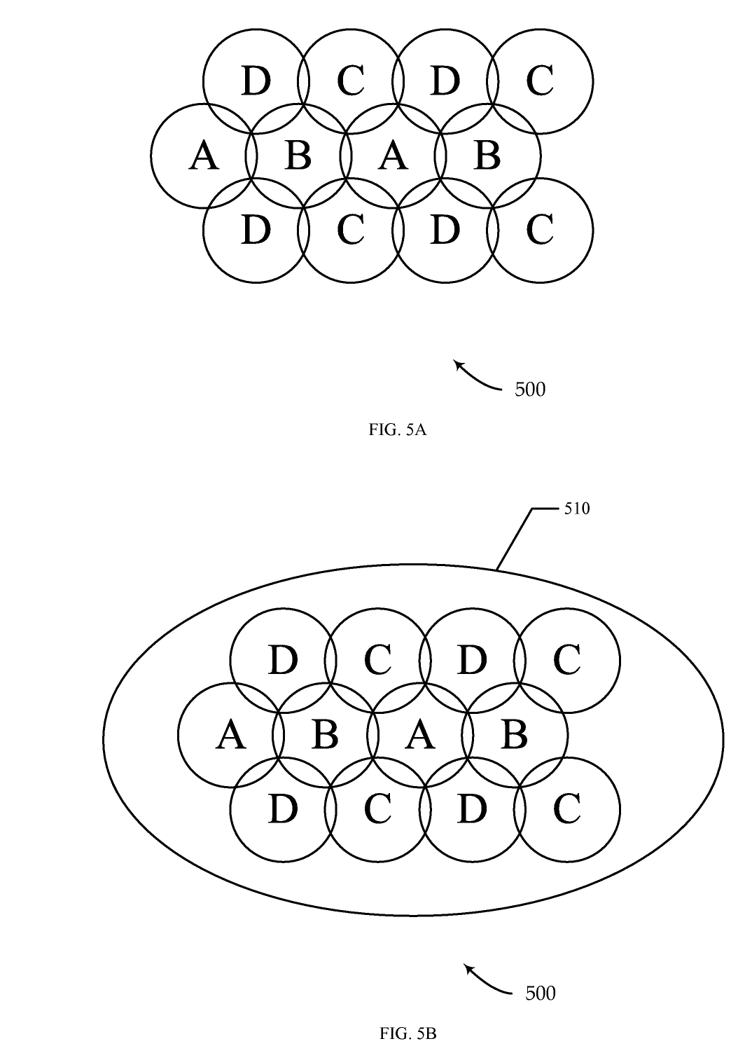

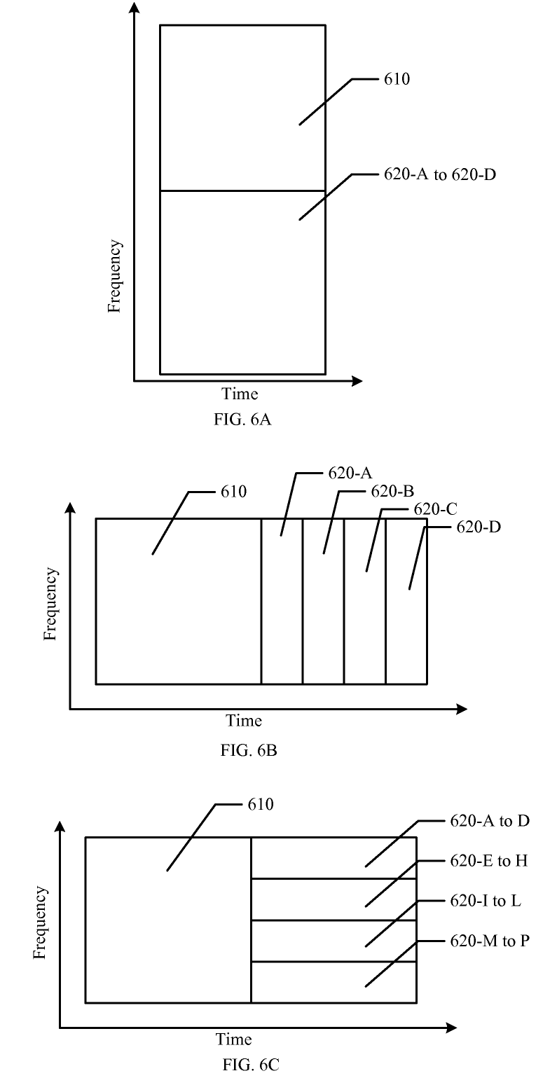

FIG. 5A shows a narrow beam pattern 500 according to another embodiment. Sixteen narrow beams are shown in a pattern providing complete coverage over a larger geographic area. Any number of narrow beams may be used. The pattern utilizes a four color reuse pattern. Each narrow beam transmits data in different color A, B, C or D. Throughout the entire area narrow beams with the same color do not overlap. The multiplexer 220 and beam controller 240 work together to ensure that the appropriate narrow beam data is mapped to the proper narrow beam. A broad beam 510 may be transmitted over the entire area as shown in FIG. 5B. The scheduler 222 may map the narrow beam data and the broad beam data into a multiplexed signal as shown in discussed in regard to FIG. 4 and FIGS. 6A-C.

FIGS. 6A-C illustrate three exemplary time and/or frequency multiplexing schemes according to embodiments. FIG. 6A, illustrates an FDM four-color reuse pattern employed for the narrow beams to ensure that two narrow beams using the same frequency do not overlap. This embodiment uses FDM. As shown the wide beam 610 and each of the four narrow beams 620 have static frequency allocations that do not change over time. The beams can transmit continuously and operate totally independently from each other.

FIG. 6B shows a TDM approach that is used with a single-color reuse pattern synchronized over time to ensure that two overlapping beams do not operate simultaneously according to one embodiment. A downstream frame structure is also defined to partition the transmissions over time. The total amount of data transmitted using this configuration over each of the beams is identical to the first configuration. However, different transmission rates and encoding schemes are required to transmit more information in less time, etc. In this embodiment, only a single receiver is required to receive both broad beam data and narrow beam data.

FIG. 6C shows a combination of TDM and FDM approaches according to one embodiment. Specifically, a downstream frame structure is required to provide the necessary TDM partitioning, but within the narrow beam transmission time, a four-color reuse pattern is defined using an FDM scheme. For example, four sets of local data 620-A, 620-B, 620-C and 620-D can be transmitted within a first frequency band. Each of these four sets of local data may cover a four-color beam reuse pattern. In this embodiment, only a single receiver is required to receive both broad beam data and narrow beam data. The receiver may dynamically switch between the wide beam and a selected narrow beam.

Returning to FIGS. 1A-D, return service links 145 are shown. Data is sent from the subscriber terminal 130 back to the satellite 105. This data may include local data, for example Internet data and/or on demand entertainment data.

As discussed in regard to FIG. 1C, it is also possible to deploy one or more terrestrial repeaters 123 according to one embodiment. These terrestrial repeaters 123 may supplement the information transmitted from the satellite using one of a variety of modulation and encoding schemes. The terrestrial repeaters may adhere to the frequency and temporal boundaries defined within each configuration. For example, if the first configuration is used, each repeater transmits in one or more of the five statically defined frequency bands.

If either the second or third configuration is used, then a terrestrial repeater 123 shall synchronize with the downstream frame structure so that it transmits in either the wide beam region (if so desired) or in one or more of the spot beam transmission regions. Each repeater could be used to transmit complementary information in either the wide beam and/or one or more narrow beam time/frequency regions.

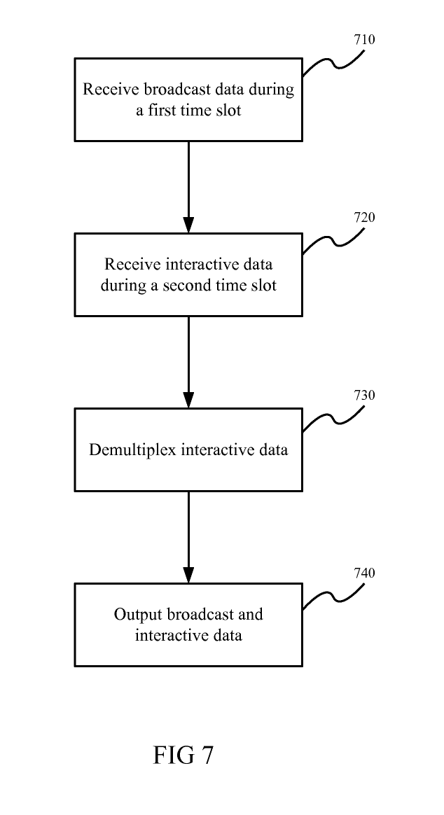

FIG. 7 shows a flowchart of a method for receiving broadcast and local data at a subscriber terminal according to one embodiment. During a first time slot, regional data is received at the subscriber terminal at block 710. The regional data may be received in a broad beam from a satellite. At block 720 local data is received during the second time slot. The local data is demultiplexed at block 730. Demultiplexing may occur within hardware or software. The local data may be multiplexed with other local data using FDMA, FDM, OFDMA, etc. Moreover, the local data may be received in a narrow beam from the satellite. At block 740, the broadcast and local data is output. Of course, all the data may not be transmitted during two timeslots. A portion of local data and regional data may be transmitted during each alternating timeslots. Control data may also be transmitted.

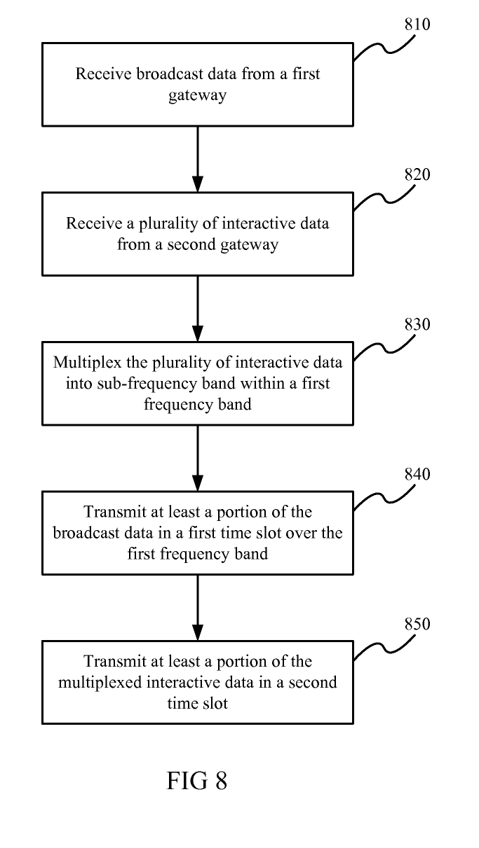

FIG. 8 shows a flowchart of a method for transmitting broadcast and local data through a satellite according to another embodiment. Regional data is received from a first gateway at block 810 and a plurality of local data is received from a second gateway at block 820. The first gateway and second gateway may be the same gateway. The local data and/or regional data may be received at various different intervals and/or may be stored in buffers. The plurality of local data may then be multiplexed into frequency sub-bands at block 830. The frequency sub-bands may be sub-bands within a first frequency band. The regional data my then be transmitted over a broad beam during a first time slot within the first frequency band at block 840. At least a portion of the local data may then be transmitted over a plurality of narrow bands during a second timeslot at block 850.

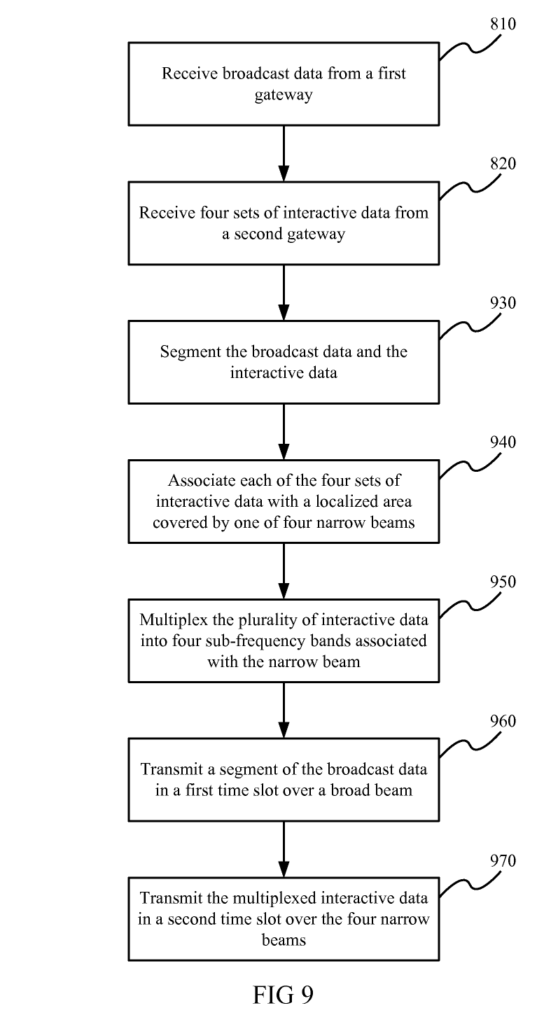

FIG. 9 shows yet another flowchart of a method for transmitting broadcast and local data according to another embodiment. Regional data is received from a first gateway at block 810 and a plurality of local data is received from a second gateway at block 820. The first gateway and second gateway may be the same gateway. The local data and/or regional data may be received at various different intervals and/or may be stored in buffers. The regional data and local data may be segmented into data segments at block 930. Theses segments may be buffered. The local data may then be associated with a localized area covered by one of four narrow beams at block 940.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein, the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

While the principles of the disclosure have been described above in connection with specific apparatuses and methods, it is to be clearly understood that this description is made only by way of example and not as limitation on the scope of the disclosure.

What is claimed is:

1. A method for receiving both regional data and local data from one or more satellites and terrestrial repeaters at a satellite subscriber terminal using a single receiver, the method comprising:
receiving the regional data during a first time slot; and
receiving the local data during a second time slot, wherein the local data is multiplexed in one of a plurality of frequency bands.

2. The method according to claim 1 further comprising demultiplexing the local data.

3. The method according to claim 1, wherein the local data is transmitted as a localized spot beam.

4. The method according to claim 1, wherein each of the plurality of frequency bands include local data for a specific locality and the local data is transmitted within a spot beam covering the specific locality.

5. The method according to claim 1, wherein the regional data is received within a first frequency band and the plurality of frequency bands are frequency sub-bands within the first frequency band.

6. The method according to claim 1, wherein the local data is multiplexed using frequency division multiple access techniques.

7. The method according to claim 1, wherein the local data is multiplexed in one of multiple frequency reuse bands.

8. A satellite subscriber terminal configured to receive both regional data and local data from one or more satellites or terrestrial repeaters, the subscriber terminal comprising:
a receiver configured to receive regional data within a first time slot and local data within a second time slot, wherein the local data is multiplexed within one of a plurality of frequency bands; and
a demultiplexer configured to demultiplex the local data from the plurality of frequency bands.

9. The satellite subscriber terminal according to claim 8, wherein the demultiplexer comprises a processor configured to perform a demultiplexing function.

10. The satellite subscriber terminal according to claim 8, wherein the regional data is transmitted within a first frequency band and the plurality of frequency bands are frequency sub-bands within the first frequency band.

11. The satellite subscriber terminal according to claim 8, wherein the local data is multiplexed using frequency division multiple access techniques.

12. A satellite subscriber terminal configured to receive both regional data and local data from one or more satellites and/or terrestrial repeaters, the subscriber terminal comprising:
means for receiving regional data from a first satellite within a first time slot and local data from a second satellite within a second time slot, wherein the local data is multiplexed within one of a plurality of frequency bands; and
means for demultiplexing the local data from the plurality of frequency bands.

13. The satellite subscriber terminal according to claim 12, wherein the first and second satellite are the same satellite.

14. The satellite subscriber terminal according to claim 12, wherein the local data is multiplexed using frequency division multiple access techniques.

15. A method for transmitting both regional data and local data to a plurality of subscriber terminals, the method comprising:
receiving regional data from a first gateway;
receiving a plurality of local data from a second gateway;
multiplexing the plurality of local data, wherein each of the plurality of local data is multiplexed into a sub-frequency band within a first frequency band;
transmitting at least a portion of the regional data in a first time slot over the first frequency band; and
transmitting at least a portion of the multiplexed local data in a second time slot over the first frequency band.

16. The satellite according to claim 15, wherein each of the plurality of local data is transmitted in a localized spot beam.

17. The satellite according to claim 15, wherein the first gateway and the second gateway comprise a single gateway.

18. The satellite according to claim 15, wherein the plurality of local data is multiplexed using frequency division multiple access techniques.

19. A satellite configured to transmit data to a plurality of subscriber terminals over a single wide beam and a plurality of narrow beams, the satellite comprising:
a first antenna configured to transmit regional data to each of the plurality of subscriber terminals over a single wide beam;
a second antenna configured to transmit a plurality of sets of local data to the plurality of subscriber terminals over a plurality of narrow beams, wherein each narrow beam transmits the sets of local data to a subset of the plurality of subscriber terminals.

20. The satellite according to claim 19, wherein the regional data is transmitted over the first antenna in a first time slot and the plurality of sets of local data is transmitted over the second antenna in a second time slot.

21. The satellite according to claim 19, wherein the satellite is configured to transmit each set of local data over a separate narrow beams.

22. The satellite according to claim 19, wherein plurality of narrow beams produce a multi color beam reuse pattern.

23. The satellite according to claim 19, wherein the regional data is transmitted within a first frequency band and each set of local data is transmitted within a sub frequency band that is a subset of the first frequency band.

24. The satellite according to claim 19, wherein the first antenna and the second antenna comprise a single antenna.
